(19) United States
(12) Patent Application Publication
(10) Pub. No.: US 2005/0126705 A1
(43) Pub. Date: Jun. 16, 2005

(54) Seal portion heating method for resinous tube

(76) Inventor: Toshitada Sakai, Funabashi City (JP)

Correspondence Address: Paul A. Fattibene;Fattibene and Fattibene, 2480 Post Road, Southport, CT, 06490, US

(21) Appl. No.: 10/735,957

(22) Filed: Dec. 15, 2003

(51) Int. Cl. B29C 53/00; B32B 31/20

(52) U.S. Cl. 156/308.4; 156/69; 156/217

(57) ABSTRACT

The present invention provides a seal portion heating method for a resinous tube which is applied to a seal portion heating apparatus for a resinous tube which is constituted so as to spout hot blow from a spout hole in a nozzle distal end portion to heat an end portion inner peripheral portion of a resinous tube serving as a clamped and sealed portion, wherein the resinous tube is rotated during heating of the end portion inner portion of the resinous tube serving as the clamped and sealed portion of the resinous tube. Therefore, in the seal portion heating apparatus for a resinous tube, the end portion of the resinous tube serving as the sealed portion is heated uniformly to obtain excellent sealing and achieve excellent appearance.

### BACKGROUND OF THE INVENTION

1) Field of the Invention

The present invention relates to a seal portion heating method for a resinous tube, and in particular to a seal portion heating method for a resinous tube which is applied in a seal portion heating apparatus for a resinous tube which, for clamping and sealing a resinous tube to be charged with a filling material such as a cosmetic, an adhesive or the like, spouts hot blow to an end portion of the resinous tube serving as a sealed portion thereof to heat the same and softens and melts the end portion, and which can achieve excellent sealing by uniformly heating an inner peripheral portion of the end portion of the resinous tube serving as the sealed portion.

2) Description of the Related Art

A conventional resinous tube of this kind will be explained with reference to FIGS. 4 to 9. In FIG. 4, reference numeral 1 denotes a resinous tube as a finished product in which filling material such as cosmetic, adhesive or the like has been filled. The resinous tube 1 is formed from a flexible synthetic resin. A neck portion 2a with a pouring-out port (not shown) provided at one end portion of a tube main body 2 of the resinous tube 1 and a shoulder portion 2b connecting the neck portion 2a and the one end portion of the tube main body 2 over an entire circumstance are formed integrally, and a screwed cap 3 is attachably/detachably provided on the neck portion 2a Further, a filling material (not shown) is charged in the tube main body 2, and the other end portion of the tube main body 2 is clamped and sealed by thermal melt-adhesion.

Next, a method for filling a material into the resinous tube 1 and a clamping and sealing method will be explained. As shown in FIG. 5, first, a filling material F is charged in the tube main body 2 by attaching the cap 3 to the resinous tube 1 to close the pouring-out port 3 and holding the resinous tube 1 in an inverted state that the cap 3 is positioned at a lower side, and opening an end portion 2c positioned at an upper side of the tube main body 2 to insert a charging nozzle 4 for charging the filling material F into the end portion 2c.

Next, as shown in FIG. 6, a distal end portion of a nozzle 6 for hot blow ejection provided in the seal portion heating apparatus 5 is inserted by predetermined length thereof into an opening of the end portion 2c serving as a clamped and sealed portion of the resinous tube 1 by conveying the resinous tube 1 into the seal portion heating apparatus 5 to ascend the resinous tube 1.

Here, the seal portion heating apparatus 5 will be explained the nozzle 6 provided in the seal portion heating apparatus 5 has a plurality of spouting holes 6a, 6a, . . . of a simple multi-hole nozzle type which spout hot blow in radial directions and which are bored on an outer periphery of the distal end portion, and the nozzle 6 is connected to a hot blow generator (not shown) provided with a heat source. A nozzle with a simple clearance nozzle type (slit type) spout holes may be known instead of the nozzle with the simple multi-hole nozzle type spout holes 6a, 6a . . . .

The nozzle 6 is surrounded by an exhaust pipe 7 with a predetermined clearance. The exhaust pipe 7 is connected at its downstream side (an upper side in the Figure) to a blower (not shown) for sucking exhaust gas, a lower end portion of the exhaust pipe 7 is provided so as to extend slightly below the distal end portion of the nozzle 6 and is formed with a flange 7b having an opening portion 7a at a central portion, and the opening portion 7a is formed so as to have an outer diameter slightly larger than an outer diameter of the end portion 2c of the tube main body 2 which has been opened.

With this constitution, after hot blow supplied from the hot blow generator flows into the nozzle 6 and hot blow spouted from the spout holes 6a, 6a, . . . of the simple multi-hole nozzle type provided in the nozzle 6 heats an inner peripheral portion of the end portion 2c of the resinous tube 1, the hot blow flows into the exhaust pipe 7 as high temperature exhaust gas and the high temperature exhaust gas is sucked by the blower (not shown) provided at a downstream side of the exhaust pipe 7 to be exhausted to a downstream side of the exhaust pipe 7.

When the peripheral portion of the end portion 2c of the resinous tube 1 is heated to a predetermined temperature to be softened and melted, the resinous tube 1 is removed from the seal portion heating apparatus 5. Next, in a state that the end portion 2c of the tube main body 2 has been diametrically expanded in a tulip shape due to the softening and melting, as shown in FIG. 7, the tube main body 2 is conveyed such that the end portion 2c is positioned in a sealing and clamping apparatus 8 shown in FIG. 8, the soften and melted end portion 2c of the tube main body 2 is clamped, melt-adhered and sealed by a clamping potion 8a of the sealing and clamping apparatus 8.

However, in the seal portion heating apparatus 5, since hot blow spouted from the plurality of spouting holes 6a, 6a, . . . of the simple multi-hole nozzle type provided in the nozzle 6 heats the inner peripheral portion of the end portion 2c of the tube main body 2, portions of the inner peripheral portion positioned in the vicinity of the spouting holes 6a, 6a, . . . 6a are particularly heated to a high temperature to generate heated spots A, A, . . . shown in FIG. 9. Heated spots B, B, . . . are also generated on an outer peripheral portion of the end portion 2c corresponding to the heated spots A, A, . . . on the inner peripheral portion.

There is a possibility that a seal strength of the inner peripheral portion of the end portion 2c is made weak by the heated spots A, A, . . . , and an appearance of the outer peripheral portion of the end portion 2c deteriorates due to the heated spots B, B, . . . , which may result in variations in productivity. Therefore, proportional defects are increased and degree of quality assurance is lowered.

In view of the above circumstances, a technical problem to be solved for uniformly heating an end portion of a resinous tube serving as a clamped and sealed portion to obtain excellent sealing and making an appearance of the end portion of the resinous tube excellent occurs in a seal portion heating apparatus for a resinous tube, and an object of the present invention is to solve the problem.

### SUMMARY OF THE INVENTION

The present invention has been made to achieve the above-described object, and the invention provides a seal portion heating method of a resinous tube applied in a seal portion heating apparatus of a resinous tube which is constituted so as to spout hot blow from a spout hole in a nozzle distal end portion to heat an end portion inner peripheral portion of a resinous tube serving as a clamped and sealed portion, wherein the resinous tube is rotated during heating of the end portion inner portion of the resinous tube serving as the clamped and sealed portion thereof.

Accordingly, the inner peripheral surface of the end portion of the resinous tube serving as the clamped and sealed portion is heated uniformly in an inner circumferential direction and a uniform soften and melted surface can be obtained. Therefore, heated spots which appear in the conventional example do not occur on the inner peripheral surface of the end portion and excellent sealing is achieved by the uniform softened and melted surface, heated spots do not occur on the outer peripheral surface of the end portion and excellent appearance is obtained. As a result, since a stable production can be achieved without any variation in productivity, such a remarkable advantage can be achieved that degree of quality assurance can be increased.

### BRIEF DESCRIPTION OF THE DRAWINGS

FIG. 1 is a partially exploded sectional view of an embodiment of a seal portion heating apparatus of a resinous tube showing a state where a resinous tube is heated while being rotated;

FIG. 2A is a plan view of a conveying apparatus for a resinous tube;

FIG. 2B is a partially explored sectional view of the conveying apparatus for a resinous tube;

FIG. 3 is a front view showing an embodiment and showing a resinous tube formed with a uniform soften and melted surface;

FIG. 4 is a front view of a finished resinous tube;

FIG. 5 is a partially exploded sectional view showing a conventional example, and showing a charging apparatus in a state just after performing filling in a resinous tube;

FIG. 6 is a partially exploded sectional view showing the conventional example, and showing a seal portion heating apparatus for a resinous tube;

FIG. 7 is a partially exploded sectional view showing the conventional example, and showing a resinous tube, whose clamped and sealed portion has been heated;

FIG. 8 is a partially exploded sectional view showing the conventional example, and showing a clamped and sealed state of the resinous tube; and

FIG. 9 is a front view showing the conventional example, and showing a state of the resinous tube after clamped and sealed.

### EMBODIMENTS OF THE PRESENT INVENTION

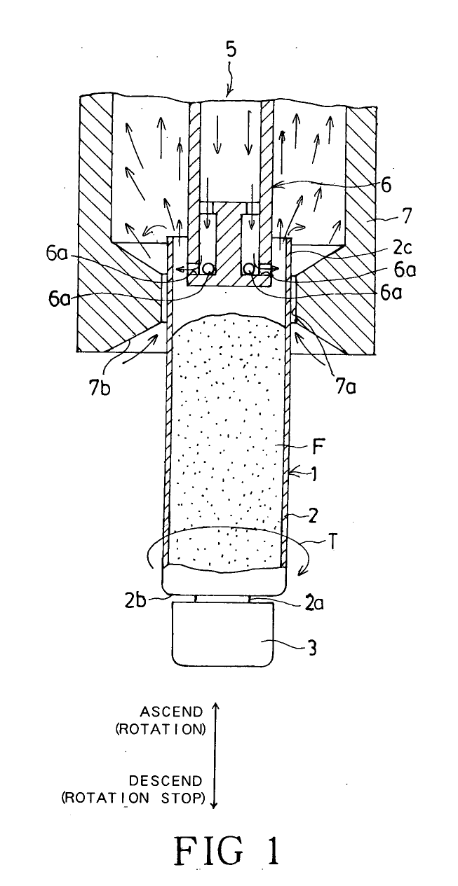

One embodiment of the present invention will be explained below in detail with reference to FIGS. 1 to 3. For convenience in explanation, like portions or parts as those in the conventional example are designated with like reference numerals as those used in the conventional example and explanation thereof will be omitted.

The present invention is constituted in a seal portion heating apparatus 5 shown in FIG. 1 such that a resinous tube 1 is rotated about an axial center of the resinous tube 1 in a direction T, during heating of an inner peripheral portion of an end portion 2c of the resinous tube 1 serving as a clamped and sealed portion thereof.

That is, in the seal portion heating apparatus 5, the resinous tube 1 is ascended to insert the end portion 2c of the resinous tube 1 serving as the clamped and sealed portion into an opening portion 7a of an exhaust pipe 7 of the seal portion heating apparatus 5 with a clearance, and the resinous tube 1 is rotated in the direction T about the axial center of the resinous tube 1 when hot blow is spouted to an inner peripheral portion of the end portion 2c of the resinous tube 1 from spouting holes 6a of a nozzle 6 of the seal portion heating apparatus 5.

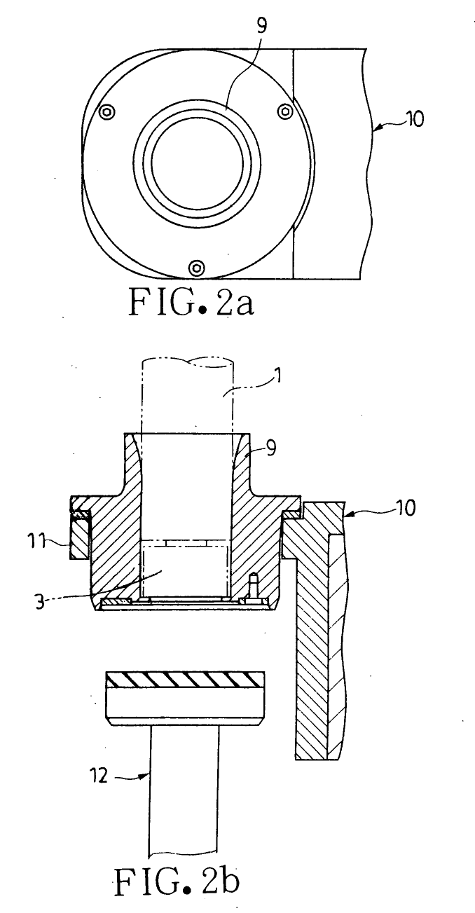

Next, a method for rotating the resinous tube 1 in the direction T will be explained with reference to FIGS. 1 and 2. The resinous tube 1 is pressure-fitted into a conveying jig 9 and the conveying jig 9 is placed on a receiving portion 11 of a conveying apparatus 10 to be conveyed. When the resinous tube 1 together with the conveying jig 9 is conveyed into the seal portion heating apparatus 5, the conveying apparatus 10 is stopped and an ascending/descending member 12 arranged below the conveying apparatus 10 is ascended so that the conveying jig 9 is placed on an upper portion of the ascending/descending member 12 and the conveying jig 9 is ascended so as to separate from a receiving portion 11. The resinous tube 1 together with the conveying jig 9 is ascended so that the end portion 2c of the resinous tube 1 is inserted into the opening portion 7a of the exhaust pipe 7 of the seal portion heating apparatus 5 with a clearance, as described above, and it is then heated.

At that time, when the conveying jig 9 or the ascending/descending member 12 is rotated, the resinous tube 1 is also rotated together with the conveying jig 9, and the end portion 2c of the resinous tube 1 is heated while being rotated. In a case that the ascending/descending member 12 is rotated, the ascending/descending member 12 and the conveying jig 9 are engaged or attracted in advance, for example, by an engaging member (not shown) or a magnet (not shown). The method for rotating the resinous tube 1 is not limited to the above-described method and another method can be used in this invention.

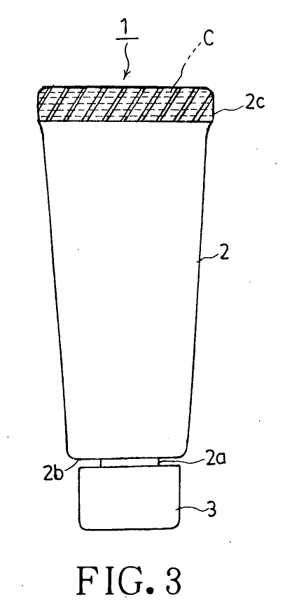

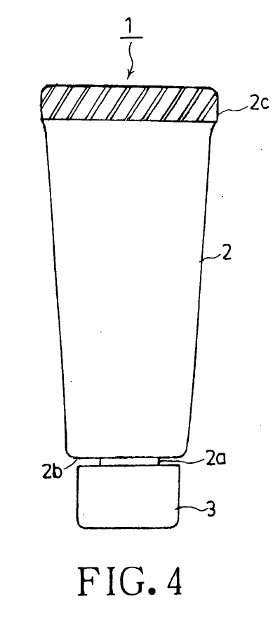

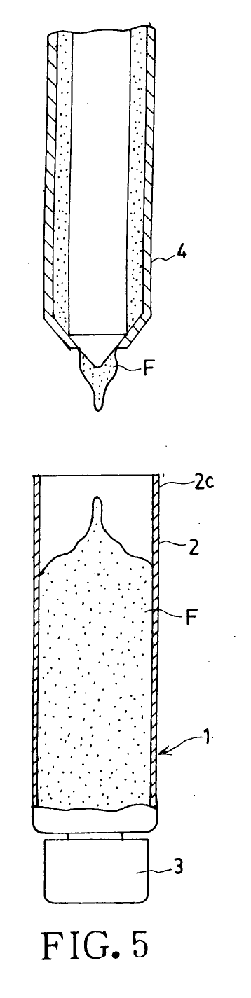

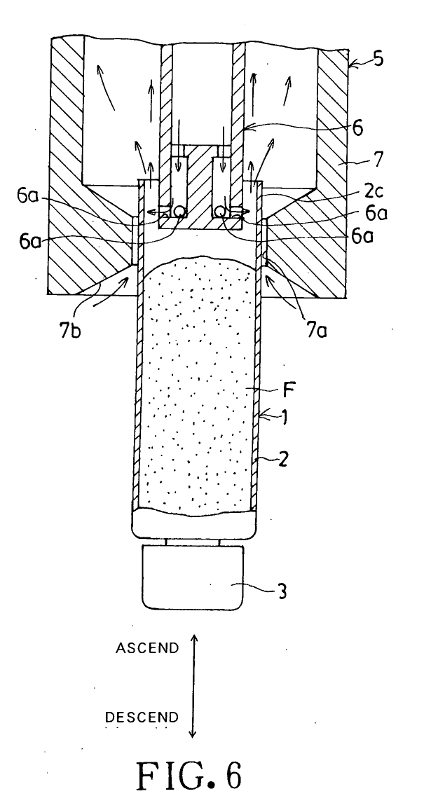

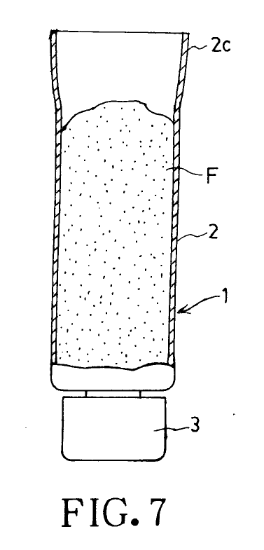

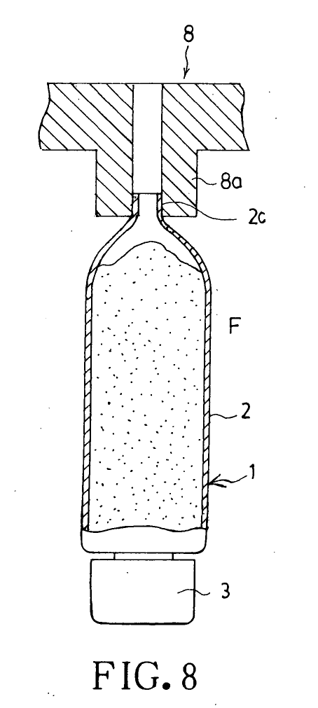

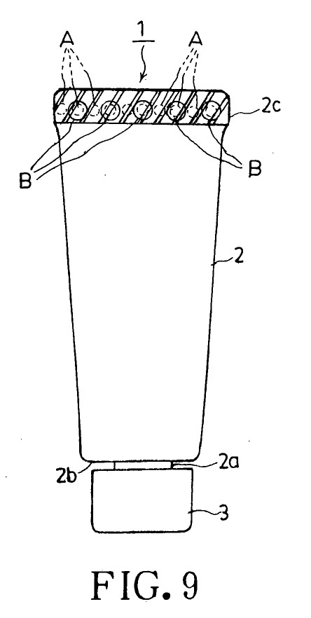

Therefore, when the end portion 2c of the resinous tube 1 is heated, the inner peripheral surface of the end portion 2c is uniformly heated especially in an inner peripheral direction by rotating the resinous tube 1, so that a uniform soften and melted surface C along inner peripheral direction can be obtained, as shown in FIG. 3.

Accordingly, heated spots which appear in the conventional example do not occur in the inner peripheral surface of the end portion 2c of the resinous tube 1 and excellent sealing can be achieved by the uniform soften and melted surface C, and heated stops do not occur on the outer peripheral surface of the end portion 2c and an excellent appearance can be obtained. Thereby, since a stable production can be achieved without any variation in productivity, degree of quality assurance can be increased.

The present invention can be modified variously without departing from the scope and spirit of the invention, and the present invention can include such a modification, of course.

1. A seal portion heating method for a resinous tube, which is applied in a seal portion heating apparatus for a resinous tube constituted so as to spout hot blow from a spout hole in a nozzle distal end portion to heat an end portion inner peripheral portion of a resinous tube serving as a clamped and sealed portion, wherein the resinous tube is rotated during heating of the end portion inner peripheral portion of the resinous tube serving as the clamped and sealed portion of the resinous tube.
